(19) United States
(12) Patent Application Publication
(10) Pub. No.: US 2026/0073503 A1
(43) Pub. Date: Mar. 12, 2026

(54) System for Assessing the Toughness of Longitudinal High Frequency Induction or Resistance Welds in Steel Tubes and Associated Method

(71) Applicant: Consejo Superior de Investigaciones Cientificas, Madrid (ES)

(72) Inventors: Ricardo Fernández Serrano, Madrid (ES); Ma Carmen Peña Fernández, Madrid (ES)

(21) Appl. No.: 19/388,401

(22) Filed: Nov. 13, 2025

Related U.S. Application Data
(63) Continuation of application No. PCT/ES2024/070297, filed on May 16, 2025.

(30) Foreign Application Priority Data
May 16, 2023 (ES) P202330376

(51) Int. Cl. G06T 7/00; B23K 31/12; B23K 37/00

(52) U.S. Cl. CPC G06T 7/0004; B23K 31/12; B23K 37/00; G06T 2207/30152

(57) ABSTRACT

A system and method for the evaluation of longitudinal welds in steel tubes, and more specifically, of longitudinal welds made by high frequency induction welding (HFW) or electric resistance welding (ERW) comprises a system for the evaluation of the toughness of longitudinal welds by high frequency induction or electric resistance welding in steel tubes and an associated method.

### CROSS-REFERENCE TO RELATED APPLICATIONS

This application is a continuation of and claims priority to PCT Application PCT/ES2024/070297, filed May 16, 2024, which, in turn, claims priority to Spanish Application P202330376 filed May 16, 2023, the entire contents of each application is incorporated herein by reference.

### BACKGROUND OF THE INVENTION

### Field of the Invention

The subject matter disclosed herein relates to the technical field of systems and methods for the evaluation of longitudinal welds in steel pipes, and more specifically, to systems and methods for the evaluation of longitudinal welds made by high frequency induction heating (HFW, High Frequency Welding) or by resistance welding (ERW, Electric Resistance Welding).

### Description of Related Art

Nowadays there are a multitude of pipes all over the world manufactured with different diameters and wall thicknesses by resistance welding or induction welding. These pipes are manufactured in different steel compositions (Grade B, X42, X52, X60, X70 and X80 in the gas transportation industry) and have application mainly for the transportation of low pressure fluids (typically<=200 bar), such as natural gas, oil or water. In addition, these pipes are used in other applications such as foundation work, the automotive industry and for the protection of communication cables.

High-frequency induction or resistance welding is a complex process that is carried out without filler material or shielding gas and in which the welding operation is determined by a large number of parameters, some of which are interrelated. These parameters affect the weld quality and the microstructure of the different typical regions called: bond line (LU), thermo-mechanically affected zone (TMAZ) and thermally affected zone (HAZ), as shown in FIG. 1.

The welding process, and in particular its adjustment, depends mainly on the chemical composition of the material used to manufacture the tube: the frequency of the induced electric field, the position of the inductor, the maximum temperature reached, the feed rate of the tube as it passes through the inductor or the resistor, the mechanical stresses applied on the material at the welding point and the angle (vee) at the point of contact of the plates.

The high frequency induction welding process generates a microstructure around the bond line (LU) with very low toughness, i.e. low resistance to crack propagation. This low toughness is microstructurally justified by the clustering of grains with the same crystallographic orientation around the bond line (LU), and also by the presence of low toughness and high hardness phases such as retained austenite or martensite. Each color in FIG. 2 represents a crystallographic orientation. Moreover, such a zone of inherent low toughness is especially damaging as it is perfectly aligned along the longitudinal direction of the tube. To avoid the low toughness of the tubes after the welding process, the welded tubes are subjected to a high temperature heat treatment called normalizing (or double normalizing), or quenching+tempering. Such treatments are usually effective in modifying, preferably to the point of practically eliminating, the detrimental microstructure around the bond line (LU) generated in the high frequency induction or resistance welding process. If such heat treatment is properly performed, brittle phases (e.g. martensite) and the clustering of grains with the same crystallographic orientation should disappear, but this is not always the case. Despite the use of single normalizing or even double normalizing post-weld treatments, low bond line (LU) toughness sometimes remains.

The evaluation of the integrity of high frequency induction or resistance welding on pipes is performed differently in the factory and when the pipe is in service. During the manufacturing process, the quality control of the pipe is performed by inspecting the process parameters used during welding (temperature, feed rate of the pipe through the inductor or resistor, stresses generated on the material at the welding point, vee angle, electrical characteristics of the induction process, etc). (“Experimental Investigation of Temperature and Contact Pressure Influence on HFI Welded Joint Properties,” Christian Egger, Martin Kroll, Kerstin Kern, Yannik Steimer, Michael Schreiner and Wolfgang Tillmann). In addition, a visual inspection of the weld is performed and in the highest quality level in the API 5L standard, PSL2, a series of destructive mechanical tests, including the impact test (Charpy test) are conducted to evaluate the toughness of the weld. Pipelines in service are periodically inspected to assess their integrity and detect the presence of cracks, corrosion damage and other defects that could jeopardize the installation.

This inspection and study of the integrity of the pipelines is usually carried out by means of systems, called PIGS (Pipeline Integrity Gauges), which travel inside the pipe thanks to the pressure of the fluid being transported in the installation and detect defects by means of technologies such as magnetic flux leakage or ultrasounds. However, the use of these systems is limited to large diameter pipes and installations designed to allow the movement of the PIG through the installation, for example, avoiding sharp bends in its path. In any case, these systems cannot determine the value of pipe toughness in service. Toughness is the key aspect that differentiates the two quality levels of HFW/ERW pipes, described as PSL1 and PSL2 according to API 5L. PSL1 pipes must meet a number of requirements, such as the chemical composition of the steel, type of pipe end finish (plain, threaded or flared), etc. PSL2 pipes, of higher quality than PSL1, have mechanical requirements on yield strength, maximum stress and toughness (resilience) at the bond line (LU). Categorizing a pipe as PSL1 or PSL2 without mechanical testing remains a challenge for the low pressure fluid transportation industry such as in gas pipelines. Furthermore, despite the fact that numerous quality controls are applied to HFW and ERW pipes both in the factory and in service, hundreds of accidents associated with the lower bond line toughness with respect to the base material of the pipe occur annually. One of the reasons for this large number of accidents is that the evaluation of the bond line (LU) toughness of new pipes in the factory has not been properly performed until the last modification of the European standard ISO 3183 Oil and natural gas industries. Steel pipes for pipeline transportation systems (ISO 3183:2019). The determination of the toughness (resilience) of the bond line (LU) according to these standards is performed by Charpy tests at low temperature (maximum 0° C.). The performance of these tests has several negative aspects such as destructive testing, cost and time required to properly machine the specimens and test time. In particular, the evaluation of the bond line (LU) toughness requires the specimens to be machined with a very high precision with respect to the bond line (LU), +/−250 μm around the bond line (LU) at most. This procedure has been included in the latest version of ISO 3183:2019 but although it allows evaluating the bond line (LU) toughness of HFW and ERW tubes, it is also a destructive evaluation procedure.

In recent years, promising new systems have been developed to evaluate in-service pipe toughness nondestructively by mechanical surface testing by performing controlled scratching or peeling processes on the pipe surface, as in “Nondestructive Evaluation for Yield Strength and Toughness of Steel Pipelines” S. D. Palkovic, K. Taniguchi, S.C. Bellemare: Massachusetts Materials Technologies, LLC, Cambridge, MA 2: Massachusetts Institute of Technology, Cambridge, MA. Conference: NACE 2018. At: Phoenix, AZ. These methods perform a friction-slip procedure and characterize the generated grooves or ligaments to respectively evaluate the hardness and toughness around the bond line (LU). However, this method is not purely experimental and relies on the use of data from finite element simulations. Furthermore, the above paper acknowledges that further testing and calibration is still needed to validate the method in real cases.

In addition, the current global decarbonization trend has led to the reuse of gas transportation infrastructures to transport hydrogen or mixtures of hydrogen and other gases (mainly natural gas). The presence of hydrogen in gas pipelines will reduce the toughness of components, mainly welds, including HFW/ERW. Such reduction in toughness is directly related to the presence of high hardness zones, strong microstructural gradients and compositional segregations (e.g. MnS). At the moment there is no system that allows evaluating the toughness of HFW/ERW welds in air, hydrogen or hydrogen/natural gas mixtures with other gases in a non-destructive way.

Thus, it would be desirable to provide a system for the evaluation of the toughness of longitudinal welds by high-frequency induction or by resistance in steel tubes and the associated method to solve the above-described drawbacks.

### BRIEF DESCRIPTION OF THE INVENTION

The subject matter disclosed herein describes a system for the evaluation of the toughness of longitudinal welds by high-frequency induction or by resistance in steel tubes and the associated method to solve the above-described drawbacks.

The present invention relates to a system for the evaluation of the toughness of longitudinal high frequency induction welds (HFW) or electric resistance welds (ERW) on steel pipes which provides a systematic and non-destructive evaluation of the bond line toughness from the microstructure characteristics around the bond line in the outer or inner zones of the pipe, on steel pipes that provides a systematic and non-destructive evaluation of bond line toughness from the characteristics of the microstructure around the bond line on the outside of the pipe in the area of the longitudinal weld made by high frequency induction heating or resistance heating without mechanical testing.

A system for evaluating the toughness of longitudinal high frequency induction or resistance welds in steel tubes comprises:
image acquisition means configured to acquire, in use, at least a two-dimensional image of an outer or inner surface of the tube in an analysis region around a bond line (LU) of the longitudinal weld, wherein the two-dimensional image comprises a first dimension essentially perpendicular to the bond line of the weld and a second dimension essentially parallel to the bond line, and wherein the two-dimensional image comprises data associated with the microstructure of the tube in the analysis region;
processing means configured to provide from the data associated with the microstructure of the tube in the analysis region, a greyscale profile with respect to the first dimension; and
analysis means configured to analyze the greyscale profile and categorize the toughness of the tube in the analysis region around the bond line of the longitudinal weld.

In this way, by means of the at least one two-dimensional image it is possible to obtain the greyscale profile of the different zones of the tube microstructure around the bond line in the analysis region, where the analysis region preferably corresponds to a thermo-mechanically affected zone (TMAZ). More preferably, the analysis region is a 25×25 mm region.

Thus, it is possible to categorize the bond line (LU) toughness from an image of the outer or inner surface of the tube, preferably considering the microstructural gradients in the zone and optionally the hardness of the zone under study or compositional segregations. The toughness requirement to categorize a tube as PSL2 is based on the material having a homogeneous microstructure (including crystallographic orientation), around the bond line, and optionally on there being no zones of high hardness, nor significant compositional segregations (e.g. MnS). During the tube manufacturing process, microstructural gradients, including heat treatments, are generated in the analysis region.

The microstructure of the material around the bond line, for the steels used to manufacture the tubes that are welded by high frequency induction or resistance welding is mainly composed of ferrite and pearlite or bainite, although in some grades from X60 onwards it is also possible to find retained austenite and/or martensite. If the welding process or the subsequent quenching and tempering or normalizing heat treatments have not been carried out correctly, the toughness of the weld is not adequate and this low toughness is reflected in some aspects of the microstructure.

The system of the present invention provides a systematic and non-destructive evaluation of the toughness of the bond line from the characteristics of the microstructure around the bond line in the outer or inner zones of the tube in the area of the longitudinal weld.

Optionally, the system further comprises means for coupling the image acquisition means to the tube. Preferably, the coupling means comprise a support comprising a lower edge having a curvature essentially equal to the curvature of the tube.

Optionally, the coupling means comprise anchoring means configured to attach the image acquisition means to the surface of the tube. Preferably, the anchoring means comprise magnetic or electromagnetic anchors.

Optionally, the system further comprises automatic grinding means configured, in use, to remove the outer or inner layers of the tube, preferably paint and rust, down to the metallic material.

Optionally, the system further comprises sanding means configured, in use, to sand the metallic material of the tube.

Optionally, the system further comprises polishing means configured, in use, to obtain a mirror-like glossy finish on the tube.

Optionally, the system further comprises chemical means configured, in use, to chemical etch the tube.

Optionally, the system further comprises cleaning means configured, in use, to wash away the film left on the tube by the chemical means and leave no marks in the analysis region.

Optionally, the image acquisition means are digital image acquisition means.

Optionally, the system further comprises a robotic module configured to move along the tube the surface cleaning means and/or the image acquisition means.

The invention also relates to a method for the evaluation of the toughness of longitudinal welds by high-frequency induction or resistance welding in steel tubes comprising:
an image acquisition stage wherein at least one two-dimensional image of an outer or inner surface of the tube is acquired in an analysis region around a bond line (LU) of the longitudinal weld, wherein the acquisition stage is carried out such that the two-dimensional image comprises a first dimension essentially perpendicular to the bond line of the weld and a second dimension essentially parallel to the bond line, and wherein in the acquisition stage data associated with the microstructure of the tube in the analysis region are obtained from the two-dimensional image;
a processing stage where a greyscale profile with respect to the first dimension is provided from the data associated with the microstructure of the tube in the analysis region; and
an analysis stage where the greyscale profile is analyzed and the toughness of the tube in the analysis region around the longitudinal weld bond line is categorized.

Optionally, the method further comprises a stage of evaluating the hardness of the area around the bond line (LU) from the obtained greyscale profile.

Optionally, the method further comprises a coupling stage to the tube prior to the image acquisition stage.

Optionally, the method further comprises an automatic roughing stage wherein the outer or inner layers of the tube are removed down to the metallic material.

Optionally, the method further comprises a sanding stage wherein the sanding of the metallic material of the tube is carried out.

Optionally, the method further comprises a stage of polishing the tube to obtain a mirror-like bright finish of the tube.

Optionally, the method further comprises a stage of chemical etching of the tube.

Optionally, the method further comprises a cleaning stage wherein the film left on the tube after the chemical etching stage is removed.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 shows a view of the different regions of the tube around the bond line;

FIG. 2A shows a scanning electron microscopy image of the backscattered electron diffraction type applied to an analysis region around a bond line (LU) of the longitudinal weld for a low toughness X60 tube without normalizing treatment;

FIG. 2B shows a scanning electron microscopy image of the backscattered electron diffraction type applied to an analysis region around a bond line (LU) of the longitudinal weld for an X60 PSL2 pipe according to API 5L standard;

FIG. 3A shows a perspective view of the image acquisition means arranged in the coupling means of the system for the evaluation of the toughness of longitudinal welds by high frequency induction or by resistance in steel pipes of the present invention;

FIG. 3B shows a perspective view of the image acquisition means arranged in the coupling means of the system located inside the tube for the evaluation of the toughness of longitudinal welds by high frequency induction or by resistance in steel tubes of the present invention;

FIG. 4 shows a schematic view of the system for the evaluation of the toughness of longitudinal welds by high frequency induction or resistance welding in steel tubes of the present invention;

FIG. 5A shows the microstructural zone around the bond line for a first master specimen (Master 1) without normalizing treatment, with low toughness for the X60 steel tube of FIG. 2A;

FIG. 5B shows the microstructural zone around the bond line for a sample with normalizing treatment, high toughness AT for the X60 steel tube in FIG. 2B;

FIG. 6 shows the toughness value (CVN) at the bond line of tubes with different normalized microstructural gradients in the analysis region obtained according to the method of the present invention; and

FIG. 7 shows the Vickers hardness values, HV10, around the bond line for various HFW high frequency induction heating welds.

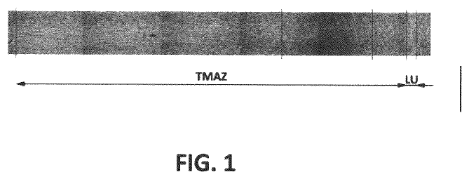

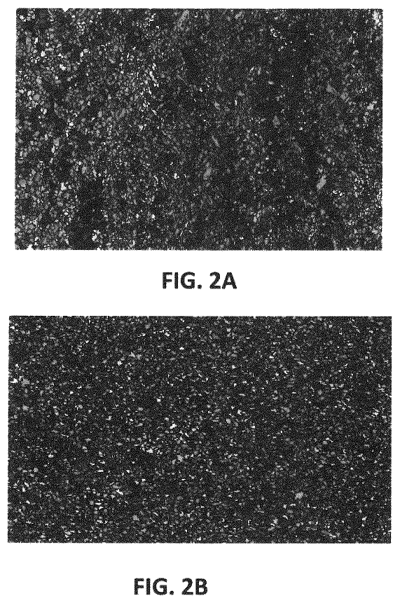

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE INVENTION

The various features and advantageous details of the subject matter disclosed herein are explained more fully with reference to the non-limiting embodiments described in detail in the following description.

It is an object of the invention to provide a system for the evaluation of the toughness of longitudinal welds by high frequency induction or resistance welding in steel tubes and an associated method, where the associated method can be carried out in air or in the presence of gases which can embrittle the steel, such as hydrogen or mixtures of hydrogen with other gases.

The following is a detailed description of the system for the assessment of the toughness of longitudinal high frequency induction or resistance welds in steel tubes of the present invention, wherein the system comprises:
image acquisition means (1) configured to acquire, in use, at least a two-dimensional image (2) of an outer or inner surface of the tube (10) in an analysis region (RA) around a longitudinal bond line (LU), wherein the two-dimensional image (2) comprises a first dimension (2x) essentially perpendicular to the weld bond line and a second dimension (2y) essentially parallel to the bond line (LU), and wherein the two-dimensional image (2) comprises data associated with the microstructure of the tube (10) in the analysis region (RA);
processing means (3) configured to provide, from the data associated with the microstructure of the tube (10) in the analysis region (RA), a greyscale profile (4) with respect to the first dimension (2x); and
analysis means (5) configured to analyze the greyscale profile (4) and categorize the toughness of the tube (10) in the analysis region (RA) around the bond line (LU) of the longitudinal weld.

Preferably, the system further comprises coupling means (6) of the imaging means (5) to the tube (10), wherein the coupling means (6) comprise a support which in turn comprises a bottom edge with a curvature essentially equal to the curvature of the tube.

### EXAMPLE 1

The method of the present invention comprises in a first stage the preparation of the outer or inner surface of the tube. The tubes must be prepared superficially according to the protocol described below:
1.—Automatic grinding using an abrasive disc to remove the outer layers of paint and rust from the pipe down to the metal material. It is necessary to grind an area of at least 2000 mm² with the width and height of this area being similar.
2.—Automatic sanding sequence with sanding discs from coarse to finer grit: 80-240-320, eliminating the marks of the previous sanding at each stage; and/or
3.—Manual sanding sequence with 400, 600, 1200 and 2000 grit sanding discs, alternating the sanding direction between sanding discs. By means of this sequence, scuff marks and scratches from the previous sequence are eliminated.
4.—Manual polishing with 3 μm diamond paste applied with a polishing cloth, which leaves a shiny mirror finish.
5.—etching with an alcoholic solution of nitric acid, for a period of time of between 15 and 60 seconds, depending on the chemical composition of the tube studied, where the nitric acid is in a concentration of less than or equal to 5%. The process is carried out manually using cotton wool soaked in the acid. In this stage, it is essential to avoid contact between the acid and the paint on the tube, so as not to soil the area under study.
6.—Cleaning with ethanol and drying of the surface, preferably with forced air (dryer) to remove the ethanol film and not leave marks on the area under study.

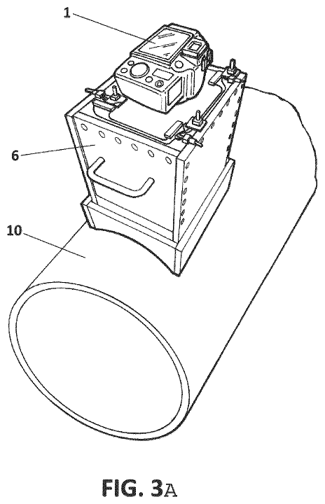

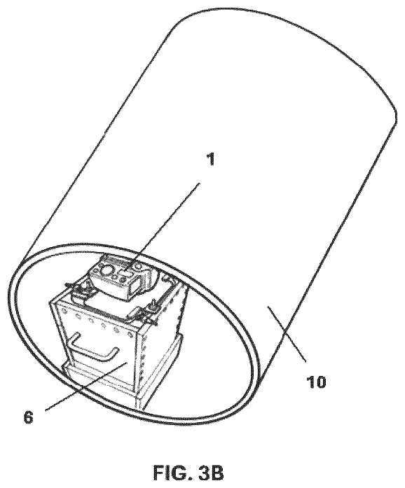

Once the surface has been suitably prepared according to stages 1 to 6, the image acquisition stage proceeds using a device developed to attach to the outer surface of the tube, shown in FIG. 3.

The images to evaluate the toughness of the bond line (LU) of HFW/ERW tubes are obtained by means of an image acquisition means, preferably a digital camera, coupled to a coupling means or box that is coupled to the outer surface of the tube, made of mechanically resistant material and opaque to the bond line (LU) with an opening that allows the camera to be coupled to take the images.

The images of the bond line (LU) obtained are subsequently evaluated by means of processing means configured to provide, from the data associated with the microstructure of the tube in the analysis region, a greyscale profile with respect to the first dimension, describing the different microstructural zones around the bond line (LU) including the analysis region (RA) that corresponds to the TMAZ. The digital camera allows the adjustment of the different parameters such as bond line (Luminance, focus and ISO) and is configured to acquire a representative image of the area around the bond line (LU) of the weld.

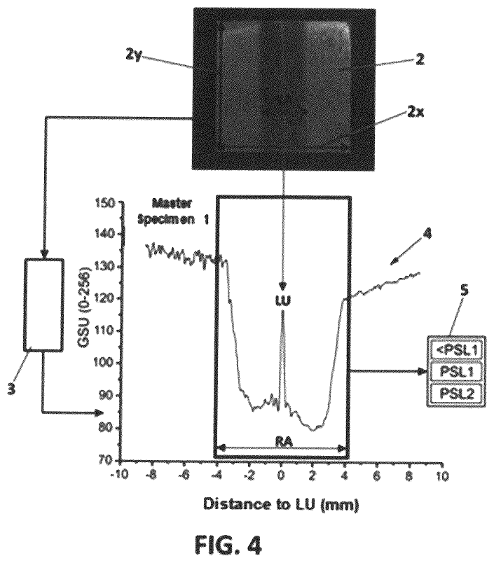

The image acquisition stage is performed as follows:
1.—Delimitation of the analysis area of, preferably 25×25 mm around the junction line (LU) by applying a black mask that adapts to the surface of the tube and eliminates parasitic reflections. It is necessary to incorporate a sample pattern or scale that allows converting the pixel value of the image to mm, FIG. 4.
2.—Placement of the image acquisition device. The image acquisition device with the appropriate coupling to the curvature of the tube shall be attached to the area of interest.
3.—Placement of the master specimen in the tube next to the area of interest. Specifically, a first master specimen (Master 1) (A) and a second master specimen (Master 2) (B) will be used as master specimens due to their proven low toughness in the bond line (LU).

The use of master specimen(s) is convenient for several reasons:
a.—to establish an objective comparison of the slightly different illumination conditions that are sometimes necessary to use to get a good image of the sample under study.
b.—to establish a reliable reference for the toughness value of a standardized grey profile in image analysis.
c.—the influence of lighting conditions/sample preparation can be normalized by modifying the grey level of the image using image analysis software and normalized by the average grey level of the profile.
4.—Illumination of the sample. Adequate illumination of the sample is achieved by using a double longitudinal LED light source of at least 10 cm in length. This requirement has been found to be necessary to adequately contrast the bond line (LU) with respect to the surrounding area. The power of the LEDs does not necessarily have to be a fixed value because it has to be considered in combination with the parameters exposure time(S), aperture and ISO of the camera when taking the image. That is to say, using a high light power with low S, aperture and ISO parameters is equivalent to using a low light power and high S, aperture and ISO values.

A fundamental aspect in the present invention is to acquire a homogeneous image with respect to its illumination; i. e:
free of artefacts or reflections.
independent of natural illumination.
5. Image acquisition of the area of interest (including the master specimens). It is advisable to acquire at least three images at different positions along the bond line (LU) to analyze the reproducibility of the result. Imaging conditions. Focus and exposure time. Once the sample has been illuminated, focusing of the image for analysis should be performed centered on the bond line (LU). Image analysis shall be performed on the images taken from the tubes using the device without any modification of brightness or contrast, and without applying any filters or modifications to the images.
6.—Analysis of the images obtained. A rectangular area centered on the bond line (LU) up to the edge of the TMAZ is taken for image analysis, as shown in FIG. 4. The rectangular area should be centered on the bond line (LU) and be wide enough to completely include the analysis region (RA) on both sides of the bond line (LU). The height of the rectangular area should ideally be 10 mm. In this way, the noise of the grey profile is smoothed and the effect of misalignment of the LU on the result is minimized.

If the height of the chosen area were too small, e.g. 3 mm, the result would be very noisy. If, on the other hand, it were too large, e.g. 20 mm, there would be a high probability that the misalignment around the bond line (LU) would be distorted.

If the bond line (LU) is not a straight line, the rectangular area must be located so that the upper half of the bond line (LU) is on one side of the axis of the rectangular area and the lower half of the bond line (LU) is on the other side.

Taking into account all the aspects described above, the analysis region (AR) is usually in the range 100-200 in greyscale. Shade 0 corresponds to the color black and shade 255 to the color white.

The analysis area has been correctly selected if the obtained greyscale profile reveals the peak corresponding to the bond line (LU) and the change in change in shade of grey between the analysis region (RA) and the adjacent material.

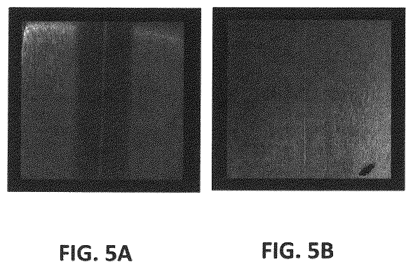

FIGS. 5A and 5B show the microstructural zones around the bond line (LU) for a sample without normalizing treatment, low toughness, master specimen 1 (FIG. 5A) and one with normalizing treatment, high toughness, AT (FIG. 5B). It can be seen how the different heat treatment generates different shades of grey around the bond line (LU).

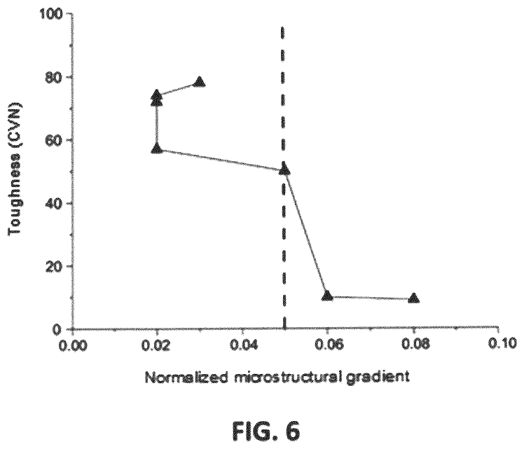

The categorization of the bond line (LU) toughness of the weld is made on the basis of the microstructural gradients described in grey scale around the bond line (LU), FIGS. 5A and 5B, with respect to the grey scale units (GSU) corresponding to the baseline of the bond line (LU). The basis of the present invention is based on the idea that when the microstructural gradient is greater than a given value, the weld has not been performed correctly and the bond line (LU) behaves as a metallurgical notch which greatly decreases the toughness of the bond line (LU). To characterize the metallurgical notch effect, Charpy tests have been performed on samples with different processing and the CVN values have been correlated with the microstructural gradient in the region of the analysis region (RA). This microstructural gradient value, which is identified with the presence of a metallurgical notch, has been calculated as 0.05 from the results obtained and described in FIG. 6. FIG. 6 shows the value of the toughness (CVN) at the bond line (LU) of tubes with different microstructural gradients in the region of analysis (RA).

The evaluation of the bond line (LU) toughness is performed using a scoring system shown in FIG. 6 based on the value of the normalised gradient in the region of analysis (RA). The tube is considered to have low toughness if there is a value of T greater than 0.05 being:

$$T = ( \frac{GSU ( RA )}{{GSU}_{0}} ) / width RA ( mm ) = 0.05 \qquad ( 1 )$$

where GSU₀ is the grey shade of the base of the peak corresponding to the bond line (LU) and GSU(RA) is the arithmetic difference between the highest and lowest grey shade in the analysis region (RA)

### EXAMPLE 2

The method of the present invention comprises in a first stage the preparation of the inner surface of the tube. The surface of the tube must be prepared following the protocol described below:
1.—Laser cleaning by means of a device developed to be coupled to a robotic crawler to remove the layers of paint and rust from the tube until reaching the metallic material. It is necessary to clean an area of at least 2000 mm² being the width and height of this area similar.
2.—Chemically etching with an alcoholic solution of nitric acid by means of a device developed to be coupled to the robotic system, for a period of time of between 15 and 60 seconds, depending on the chemical composition of the tube studied, where the nitric acid is in a concentration of less than or equal to 5%. In this stage, it is essential to avoid contact between the acid solution and the paint on the tube, so as not to soil the area under study.
3.—Cleaning with ethanol and drying of the surface, preferably with forced air (dryer) to drag the ethanol film and not leave marks on the area under study.

Once the surface has been conveniently prepared according to stages 1 to 3, the image acquisition stage is carried out using a device developed to be coupled to the robotic system described above, which moves it along the inside of the tube to analyze the inner surface of the tube, shown in FIG. 3B.

The images for evaluating the toughness of the bond line (LU) of HFW/ERW tubes are obtained by means of an image acquisition means, preferably a digital camera, coupled to a coupling means mounted on the robotic system. The obtained bond line (LU) images are further evaluated by processing means configured as described in example 1. The digital camera allows the adjustment of the different parameters (Brightness, focus and ISO) and is configured to acquire a representative image of the area around the bond line (LU) of the weld. The image acquisition stage is performed as follows:
1.—Delimitation of the analysis area, preferably 25×25 mm² around the bond line (LU) by applying a black mask that adapts to the surface of the tube and eliminates parasitic reflections.

Positioning of the image acquisition device by displacement of the robotic system. The image acquisition device mounted on the robotic system shall be attached to the area of interest.
3.—Placement of the master specimen in the tube next to the area of interest by means of the robotic system. Specifically, a first master specimen (Master 1) (A) and a second master specimen (Master 2) (B) will be used as master specimens due to their proven low toughness in the bond line (LU). The use of master specimen(s) is convenient for the reasons described in example 1:
4.—Illumination of the sample in the same manner as described in example 1.
5.—Image acquisition of the area of interest (including the master specimen) in the manner described in example 1.
6.—Analysis of the images obtained following the procedure described in example 1.

The categorization of the toughness of the bond line (LU) of the weld is performed in the same way and with the same equation as described in example 1.

### EXAMPLE 3

The method of the present invention comprises in a first stage the preparation of the inner surface of the tube. The surface of the tubes must be prepared following the protocol described below:
1.—Automatic grinding using an abrasive disc to remove the outer layers of paint and rust from the tube down to the metallic material. It is necessary to grind an area of at least 2000 mm² being the width and height of this area similar.
2.—Automatic sanding sequence with sanding discs from coarse to finer grit: 80-240-320, removing the marks of the previous sanding at each stage; and/or it is not always necessary to use all the sanding discs.
3.—Manual sanding sequence with 400, 600, 1200 and 2000 grit sanding papers, alternating the sanding direction between the sanding papers. By means of this sequence, scuff marks and scratches from the previous sequence are eliminated.
4.—Manual polishing with 3 μm diamond paste applied with a polishing cloth, which leaves a shiny mirror-like finish.
5.—Chemical etching with an alcoholic solution of nitric acid of concentration less than or equal to 5%, for a period of time of 30 seconds, followed by cleaning with alcohol and drying.
6.—Acquisition of the image using a device developed to attach to the outer surface of the tube, shown in FIG. 3A.
7.—Chemical etching with an alcoholic solution of nitric acid of concentration less than or equal to 5%, for a period of time of 15 seconds, followed by cleaning with alcohol and drying.

Acquisition of the image using a device developed to attach to the outer surface of the tube, shown in FIG. 3A.
9.—Chemical etching with an alcoholic solution of nitric acid of concentration less than or equal to 5%, for a period of 15 seconds, followed by cleaning with alcohol and drying.

Images for assessing the bond line (LU) toughness of HFW/ERW tubes are obtained using the image acquisition means described in FIG. 3A. The image acquisition stage is performed as described in example 2.

The categorization of the bond line (LU) toughness of the gas atmosphere weld that embrittles the steel is performed by combining:
i) the calculation of the microstructural gradients described in grey scale around the bond line (LU), FIGS. 5A and 5B, with respect to the grey scale units (GSU) corresponding to the baseline of the bond line (LU). This microstructural gradient value, which is identified with the presence of a metallurgical notch, has been calculated as 0.05 based on the results obtained and described in FIG. 6 and the equation described in example 1;
ii) the calculation of the hardness around the bond line (LU). The hardness around the bond line (LU) is determined from the profiles obtained from the analysis of the images obtained. The hardness around the bond line (LU) is considered to be proportional to that of the base material, X42, X52, etc, the grain size and the phases present in the area of interest: polygonal ferrite, acicular ferrite, pearlite, bainite, retained austenite, martensite, etc. The maximum recommended hardness to avoid hydrogen embrittlement in pipeline steels is considered as 275 HV.

By means of the imaging technique, we can determine the variations in hardness with respect to the bond line (LU) corresponding in the grey profiles to the central peak. The higher the hardness (finer the grain and finer the pearlite/bainite/martensite), the faster the nital etching.

The procedure consists of etching with nital around the bond line (LU) for several times and then cleaning with alcohol and drying, making an image acquisition after each of the etching, cleaning and drying processes. An image of the area of interest is acquired and the descriptive profile of the area of interest is calculated. The process is repeated with a longer etching time, for example an additional 30 seconds, followed by cleaning and drying and images are acquired again and the corresponding profile is calculated. The process is repeated a third time (without prejudice to repeating the process as many times as necessary) with a longer etching time, e.g. an additional 30 seconds, and an image is re-acquired and the corresponding profile is calculated. In this case the total etching time with nital would be 90 seconds.

The difference in grey shade between the three profiles is then calculated for the 30, 60 and 90 second etching times. The GSU grey values decrease with etching time as a function of the microstructure around the bond line (LU).

The determination of the hardness starts by assigning a HV value to the base material which can be obtained from the yield strength requirement of the base material according to the standards. The following hardness values are considered for the base material: 160 HV for X42, 170 HV for Grade B. and 190 HV for X60.

The hardness value around the LU increases with respect to the base material if the microstructure is fine-grained with a perlitic/bainitic structure. This type of microstructure is evident in a grey shade profile in which the bond line (LU) (central peak of the profile) is rapidly revealed (<30 s) and this profile is maintained for consecutive etching s up to high etching times, e.g. 90 seconds. However, if the microstructure around the bond line (LU) is coarse-grained pearlitic, a decrease in hardness occurs. In this coarse microstructure it is typical that no decrease in grey shades (GSU) occurs until high etching times. There is a relationship between hardness and GSU. In Grade B and X42 materials the ratio is inversely proportional to 1 HV: 3 GSU. In the X60 material the ratio is 1 HV: 1 GSU. The decrease in hardness is inversely proportional to the decrease in GSU.

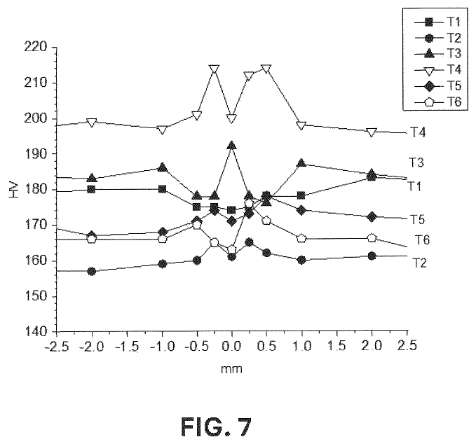

The hardness predictions made according to the method described for the curves summarized in FIG. 7 are shown below.

T1: When the nital etching is performed, there is a progressive drop of 18 GSU up to 30 s indicating that the microstructure is medium (neither fine nor coarse). There is a 1 HV:3 GSU equivalence in X42 materials such as T1, therefore the hardness should increase by 6 HV around the bond line (LU) from 160 HV to 166 HV.

T2: On etching with nital, there is a progressive drop of 17 GSU up to 45 s indicating a fine grain and coarse pearlitic structure. There is a 1 HV: 3 GSU equivalence, therefore the hardness should increase by 5 HV around the bond line (LU) from 160 to 165 HV.

T3: When performing the nital etching, there is no GSU drop until 45 s which drops 13 GSU. There is a 1HV: 1 GSU equivalence in X60 materials, so the hardness should drop 13 HV around the LU from 190 to 177HV.

T4: 20 GSU drop in 15 s in the nital etching to keep the profile the same until 45 s. There is a 1HV: 1 GSU equivalence in X60 materials, so the hardness should increase 20 HV around the LU from 190 to 210 HV.

T5: The weld is slightly asymmetrical. When etching with nital, there is a drop of 15 GSU on the sides of the LU from 220 GSU in just 15 s which is maintained until 45 s. There is a GSU to HV equivalence of 1 HV: 3GSU typical of X42/Grade B materials such as T5, therefore, hardness should increase by 5 HV around the bond line (LU) from 170 to 175 HV.

T6: The weld is asymmetrical. When the nital etching is performed, there is a drop of 5 GSU on the sides of the bond line (LU) in only 15 s which is maintained until 45 s. There is an equivalence of 1HV: 3 GSU in materials such as T6. The hardness has to increase 1-2 HV around the LU from 170 to 172 HV.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A system for assessing the toughness of longitudinal high frequency induction or resistance welds in steel tubes, comprising:
an image acquisition means configured to acquire, in use, at least a two-dimensional image of an outer or inner surface of the tube in an analysis region (RA) around a bond line (LU) of the longitudinal weld, wherein the two-dimensional image comprises a first dimension (2x) essentially perpendicular to the bond line of the weld and a second dimension (2y) essentially parallel to the bond line (LU), and wherein the two-dimensional image comprises data associated with the microstructure of the tube in the analysis region (RA);
a processing means configured to provide, from the data associated with the microstructure of the tube in the analysis region (RA), a greyscale profile with respect to the first dimension (2x); and
an analysis means configured to analyze the greyscale profile and categorize the toughness of the tube in the analysis region (RA) around the bond line (LU) of the longitudinal weld.

2. The system according to claim 1, wherein the analysis region preferably corresponds to a thermo-mechanically affected zone (TMAZ).

3. The system according to claim 1, further comprising a coupling means of the image acquisition means to the tube, wherein the coupling means comprise a base further comprising a bottom edge with a curvature essentially equal to the curvature of the tube.

4. The system according to claim 3, wherein the coupling means comprise anchoring means configured to attach the imaging means to the surface of the tube, preferably magnetic or electromagnetic anchors.

5. The system according to claim 1, further comprising an automatic grinding means configured, in use, to remove the outer or inner layers of the tube down to the metallic material.

6. The system according to claim 5, further comprising a sanding means configured, in use, for sanding the metallic material of the tube.

7. The system according to claim 6, further comprising a polishing means configured, in use, to obtain a mirror-like glossy finish on the tube.

8. The system according to claim 7, further comprising a chemical means configured, in use, to chemically etch the tube.

9. The system according to claim 8, further comprising a cleaning means configured, in use, to remove the film left on the tube by the chemical means so as not to leave marks in the analysis region.

10. The system according to claim 9, the system further comprising a robotic module configured to move the surface preparation means and/or the image acquisition means along the tube.

11. A method for the assessment of the toughness of longitudinal high frequency induction or resistance welds in steel tubes, using the system of claim 1 comprising:
an image acquisition means configured to acquire, in use, at least a two-dimensional image of an outer or inner surface of the tube in an analysis region (RA) around a bond line (LU) of the longitudinal weld, wherein the two-dimensional image comprises a first dimension (2x) essentially perpendicular to the bond line of the weld and a second dimension (2y) essentially parallel to the bond line (LU), and wherein the two-dimensional image comprises data associated with the microstructure of the tube in the analysis region (RA);
a processing means configured to provide, from the data associated with the microstructure of the tube in the analysis region (RA), a greyscale profile with respect to the first dimension (2x); and
an analysis means configured to analyze the greyscale profile and categorize the toughness of the tube in the analysis region (RA) around the bond line (LU) of the longitudinal weld, the method comprising:
acquiring, with an image acquisition stage, at least one two-dimensional image of an outer or inner surface of the tube in an analysis region around a bond line (LU) of the longitudinal weld, wherein the acquisition stage is carried out such that the two-dimensional image comprises a first dimension essentially perpendicular to the bond line of the weld and a second dimension essentially parallel to the bond line, and wherein in the acquisition stage data associated with the microstructure of the tube in the analysis region (RA) are obtained from the two-dimensional image;
providing from a processing stage a greyscale profile with respect to the first dimension from the data associated with the microstructure of the tube in the analysis region (RA);
analyzing, with an analysis stage, the greyscale profile; and
categorizing the toughness of the tube in the analysis region around the weld bond line with the analysis stage.

12. The method according to claim 11, further comprising a tube coupling stage prior to the image acquisition stage.

13. The method according to claim 11, further comprising an automatic grinding stage wherein the outer or inner layers of the tube are removed down to the metallic material.

14. The method according to claim 13, wherein the automatic grinding stage uses an abrasive disc to remove the outer layers of the tube down to the metallic material, roughing an area of at least 2000 mm².

15. The method according to claim 13, further comprising a sanding stage wherein the sanding of the metal material of the tube is carried out.

16. The method according to claim 15, wherein the sanding stage comprises a first automatic sanding sequence with sanding disc from coarse to finer grit: 80-240-320, removing at each stage the marks of the previous sanding, and/or a manual sanding sequence with 400, 600, 1200 and 2000 grit sanding papers alternating the sanding direction between sanding papers.

17. The method according to claim 15, further comprising a stage of polishing the tube to obtain a mirror-like bright finish on the tube.

18. The method according to claim 17, wherein the polishing stage is a manual polishing stage with 3 μm diamond paste applied with a polishing cloth.

19. The method according to claim 17, further comprising a chemical etching stage of the tube.

20. The method according to claim 19, wherein the chemical etching stage of the tube is carried out with an alcoholic solution of nitric acid, for a period of time of between 15 and 60 seconds, wherein the nitric acid is at a concentration of less than or equal to 5%.

21. The method according to claim 19, wherein the chemical etching stage of the tube is carried out with an alcoholic solution of nitric acid, for a period of time of 15 seconds and a first image is acquired, then another one of 30 seconds and a second image is acquired and finally another one of 45 seconds, wherein the nitric acid is in a concentration less than or equal to 5%.

22. The method according to claim 21, wherein the hardness around the bond line (LU) is determined by the equivalence between GSU and HV from the evolution of the grey profiles for the different etching times.

23. The method according to claim 19, further comprising a cleaning stage wherein the film left on the tube after the chemical etching stage is removed.
